(19) United States
(12) Patent Application Publication
(10) Pub. No.: US 2010/0161823 A1
(43) Pub. Date: Jun. 24, 2010

(54) A STREAMING SERVICE SYSTEM AND METHOD FOR UNIVERSAL VIDEO ACCESS BASED ON SCALABLE VIDEO CODING

(76) Inventors: Soon-Heung JUNG, Daejeon (KR); Jeong Ju YOO, Daejeon (KR); Jin Woo HONG, Daejeon (KR); Kwang-Deok SEO, Gangwon-do (KR); Jae-Hyung HWANG, Incheon (KR); Won Sup CHI, Gangwon-do (KR)

Correspondence Address: LADAS & PARRY LLP, 224 SOUTH MICHIGAN AVENUE, SUITE 1600, CHICAGO, IL, 60604, US

(21) Appl. No.: 12/546,866

(22) Filed: Aug. 25, 2009

(30) Foreign Application Priority Data
Dec. 19, 2008 (KR) 10-2008-0130490

(51) Int. Cl. G06F 15/16; H04N 7/26

(52) U.S. Cl. 709/231; 375/240.26; 375/E07.078

(57) ABSTRACT

Provided is a streaming service system and method for a universal video access based on scalable video coding (SVC). A gateway to provide a streaming service may include: an SVC content file parser to receive an SVC content file from a streaming server, and to separately extract an SVC network abstraction layer (NAL unit) of a base layer and an SVC NAL unit of a scalable enhancement layer from SVC NAL units that are included in the SVC content file; an SVC NAL selection unit to select an SVC NAL unit corresponding to a client type of each of terminals; and a packet generation unit to transmit the selected SVC NAL unit to a corresponding terminal.

### CROSS-REFERENCE TO RELATED APPLICATION

This application claims the benefit of Korean Patent Application No. 10-2008-0130490, filed on Dec. 19, 2008, in the Korean Intellectual Property Office, the disclosure of which is incorporated herein by reference.

### BACKGROUND

1. Field of the Invention

The present invention relates to a streaming service system and method for a universal video access based on a scalable video coding (SVC). More specifically, the present invention relates to a streaming service system and method that may generate a content file, including a plurality of SVC video layer data into a single file format, using a pseudo streaming scheme, to thereby provide the generated content file to a home gateway.

2. Description of the Related Art

Various types of multimedia service infrastructures have been ubiquitously constructed and been developed. The above trend is being accelerated due to various types of wired/wireless communication infrastructures, a consumer's desire to access commercial contents without restriction on a time and a place, diversified multimedia contents, and disparate terminals. The appearance of various types of wired/wireless communication networks has enabled various types of new multimedia services. For example, a steady increase in an available bandwidth of a transmission channel due to the development of communication networks has made it possible to provide a high quality multimedia content service. However, because of the variety of communication networks, there is a need for an advanced adaptive video service technology in order to provide the high quality multimedia content service for every user at any time and at any place. In particular, in a home network environment, a transmission channel to a home gateway and a service target terminal may be connected using various types of schemes, for example, a telephone line with a low bandwidth, a dedicated line with a high bandwidth capable of providing a high definition video service, and the like. Also, a resolution of a display apparatus supportable by a terminal varies depending on a service type and a type of the terminal. In the above various transmission channel environments, a scalable video coding (SVC) video compression technology may be used to smoothly provide a multimedia service.

Here, SVC is an extended coding technology of H.264. Also, the SVC denotes a new extension type coding scheme that was developed at the end of 2007 in order to overcome drawbacks found in a layer coding based scalability of existing compression schemes such as MPEG-2, MPEG-4, and the like. For example, the drawbacks may include a low compression efficiency, an incapability of supporting a complex scalability, a configuration complexity, and the like. The SVC may encode a plurality of video layers into a single bitstream. Layers of the SVC may include a single base layer and scalable enhancement layers that may be consecutively disposed on the base layer. Each of the scalable enhancement layers may express a maximum bitrate, a frame rate, and a resolution that are assigned to a corresponding scalable enhancement layer, based on base layer information. The SVC may support the same amount of various bitrates, frame rates, and resolutions as consecutively disposed scalable enhancement layers. Accordingly, the SVC may be an appropriate coding technology for a multimedia content service in a universal multimedia access environment that may solve drawbacks such as disparate bandwidths in a heterogeneous network environment, various terminal performances and resolutions, various content user preferences, and the like.

The SVC may simultaneously store, in a single bitstream, coding information associated with a signal-to-noise ratio (SNR), a temporal scalability, and a spatial scalability. A wide-ranging combined scalability may be supported through an organic combination of the above three scalability information. For realization of the combined scalability, coding information of a base layer and scalability coding information of a scalable enhancement layer may be generated based on a slice unit in a video coding layer (VCL). Each slice may be generated based on a network abstraction layer (NAL) unit in a NAL, and be stored in an SVC bitstream. In order to classify correlation information between each SVC NAL unit and a corresponding scalable enhancement layer in the NAL without encoding a bitstream, a temporal_level_ID (TID) field, a dependency_ID (DID) field, and a quality_level_ID (QID) field are included in a header of each SVC NAL unit. Here, TID denotes a hierarchy between temporal layers for a temporal scalability. DID denotes a dependency hierarchy between upper and lower scalable enhancement layers in an inter-layer prediction of a spatial scalability. QID denotes a hierarchy between fine granular scalability (FGS) layers for supporting the SNR. FIG. 1 illustrates a format of an SVC NAL unit according to a conventional art. Referring to FIG. 1 information associated with TID, DID, and QID are included in three bytes of a NAL unit header extension interval. Therefore, it is possible to identify an SVC NAL unit that may satisfy a desired SNR, a temporal scalability, and a spatial scalability.

A multicasting technology is representative of technologies that enable a universal video access in a home network environment using the aforementioned SVC technology. Below is a description of performing a multicast service. Generally, a multicast service using SVC compressed video may be performed based on a service architecture of FIG. 2. FIG. 2 illustrates a structure of a system for providing a video-based multicast service according to the conventional art. Referring to FIG. 2, a multicast service may use an SVC bitstream that includes a single base layer B, and three enhancement sublayers (1, 2, 3) E1, E2, and E3. The base layer B and the enhancement sublayers (1, 2, 3) E1, E2, and E3 may communicate with H.264. A streaming server 210 may transmit the entire SVC NAL units to a home gateway 220 through a Real-time Transport Protocol (RTP) session. Here, the SVC NAL unit may constitute the SVC bitstream including a total of four layers. The home gateway 220 may extract, from the received SVC NAL units via an RTP packet filter 222, only SVC NAL units of layer information corresponding to a resolution, a quality, and a frame rate that are appropriate for each of terminals 232, 234, and 236, and a channel bandwidth. The home gateway 220 may transmit the extracted SVC NAL units to the terminals 232, 234, and 236. Accordingly, the multicast service may be performed.

Described differently, referring to FIG. 2, the terminal 232 may receive the base layer B and two upper enhancement sublayers (1, 2) E1+E2. In this case, the home gateway 220 may extract only SVC NAL units corresponding to the base layer B, and the enhancement sublayers (1, 2) E1 and E2, through filtering of the RTP packet filter 222, and transmitted the extracted SVC NAL units to the terminal 232. Also, the terminal 234 may receive the base layer B and the enhancement sublayer E1 due to a terminal capability and a channel bandwidth. In this case, the home gateway 220 may extract only SVC NAL units corresponding to the base layer B and the enhancement sublayer E1 and transmit the extracted SVC NAL units to the terminal 234. Due to an insufficient channel bandwidth, the third terminal 236 may receive only the base station B. The home gateway 220 may extract only SVC NAL units corresponding to the base station B, and transmit the extracted SVC NAL units to the terminal 236.

An RTP may be used when encapsulating SVC NAL units in an Internet Protocol (IP) network such as the Internet. Specifically, the SVC NAL units may be transferred, using an RTP packet, between the streaming server 210 and the home gateway 220, and between the home gateway 220 and the terminals 232, 234, and 236. The RTP packet may include a header and a payload. The format of the header may include 12 bytes of a basic fixed header and a header extension. The header extension may be selectively used by a user as necessary.

In the conventional art, the streaming server 210 may transfer SVC data of B. E1, E2, and E3 in RTP packets and thereby transmit the RTP packet to the home gateway 220 using a User Datagram Protocol (UDP). The home gateway 220 may extract, from the received RTP packets, only an RTP packet that is required by each of the terminals 232, 234, and 236, and thereby transmit the extracted RTP to a corresponding terminal. In this instance, when the SVC data of B1, E1, E2, and E3 is transmitted in a single NAL unit (SNU) packet type of RTP, there may be no difficulty in that the RTP packet filter 222 may perform RTP packet filtering. However, when the SVC data is transmitted in a fragmentation unit (FU) packet type, a single time aggregation packet (STAP) packet type, or a multi-time aggregation (MTAP) packet type, it may be very difficult to substantially perform RTP packet filtering.

Specifically, the SNU packet type may carry only a single NAL unit in a single RTP packet type. The STAP packet type may simultaneously carry, in the single RTP packet, a plurality of NAL units that belongs to the same presentation time instant. The MTAP packet type may simultaneously carry, in the single RTP packet, a plurality of NAL units that belongs to different presentation time instants. The FU packet type denotes a scheme that may divide NAL units into at least two units, to not exceed a maximum transmission unit (MTU) size of a network, and thereby carry, in an individual RTP packet, each of the divided units, in order to prevent a fragmentation from occurring in a router or a gateway during a transmission when the size of a single NAL unit exceeds the MTU size.

Hereinafter, a case where an RTP packet type is applied to a system providing a multicast service based on a hierarchically coded video will be described.

Initially, when a single individual NAL unit is transferred in a single independent RTP packet, a gateway may directly perform RTP packet filtering using only information associated with DID, TID, and QID that are included in a header of the SVC NAL unit. Specifically, the gateway may readily select only an RTP packet corresponding to an appropriate SNR, a temporal scalability, and a spatial scalability, to be transmitted to a corresponding terminal, based on only the information associated with DID, TID, and QID, and thereby transmit the selected RTP packet.

However, in the case of the FU packet type, a single NAL unit may be divided into a plurality of units, and thereby be transferred in a plurality of RTP packets. Therefore, RTP packet filtering may be performed for an RTP packet that includes a header with DID, TID, and QID, but may not performed for an RTP that includes the remaining portion since DID, TID, and QID are not included in the remaining portion. In the case of the STAP packet type and the MTAP packet type, a plurality of NAL units may be carried in a single RTP packet. Therefore, there is a need to perform RTP packet filtering by retrieving, from the plurality of NAL units, only a NAL unit containing DID, TID, and QID. Specifically, when a server generates an RTP packet using the FU packet type, the STAMP packet type, or the MTAP packet type, and transmits the generated RTP packet to a gateway, it may be difficult for the gateway to select an appropriate RTP packet and transfer the selected RTP packet to a terminal.

### SUMMARY

An aspect of the present invention provides a streaming service system and method for a universal video access based on a scalable video coding.

Another aspect of the present invention also provides a streaming service system and method that may generate a content file, including a plurality of scalable video coding (SVC) video layer data in a single file format, using a pseudo-streaming scheme, to thereby provide the generated content file to a home gateway.

According to an aspect of the present invention, there is provided a streaming service system including: a scalable video coding (SVC) content file parser to receive an SVC content file from a streaming server, and to separately extract an SVC network abstraction layer (NAL) unit of a base layer and an SVC NAL unit of a scalable enhancement layer from SVC NAL units that are included in the SVC content file; an SVC NAL selection unit to select an SVC NAL unit corresponding to a client type of each of terminals; and a packet generation unit to transmit the selected SVC NAL unit to a corresponding terminal.

According to another aspect of the present invention, there is provided a streaming service system including: an SVC content file generation unit to identify a base layer and a scalable enhancement layer of a hierarchically coded content, to generate an SVC content file including both the base layer and the scalable enhancement layer, and to transmit the generated SVC content file to a gateway.

According to still another aspect of the present invention, there is provided a streaming service method at a gateway, the method including: receiving an SVC content file from a streaming server; separately extracting an SVC NAL unit of a base layer and an SVC NAL unit of a scalable enhancement layer from SVC NAL units that are included in the SVC content file; selecting an SVC NAL unit corresponding to a client type of each of terminals; and transmitting the selected SVC NAL unit to a corresponding terminal.

According to yet another aspect of the present invention, there is provided a streaming service method at a streaming server, the method including: identifying a base layer and a scalable enhancement layer of a hierarchically coded content; generating an SVC content file including both the base layer and the scalable enhancement layer; and transmitting the generated SVC content file to a gateway.

### SUMMARY

According to embodiments of the present invention, there may be provided a streaming service system and method for a universal video access based on a scalable video coding that may generate a content file, including a plurality of scalable video coding (SVC) video layer data in a single file format, using a pseudo-streaming scheme, to thereby provide the generated content file to a home gateway. Through this, it is possible to provide each of terminals, communicating with a home gateway, with SVC video layer data by enabling the home gateway to readily verify a characteristic of the SVC video layer data.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 illustrates a format of a scalable video coding (SVC) network abstraction layer (NAL) unit according to a conventional art;

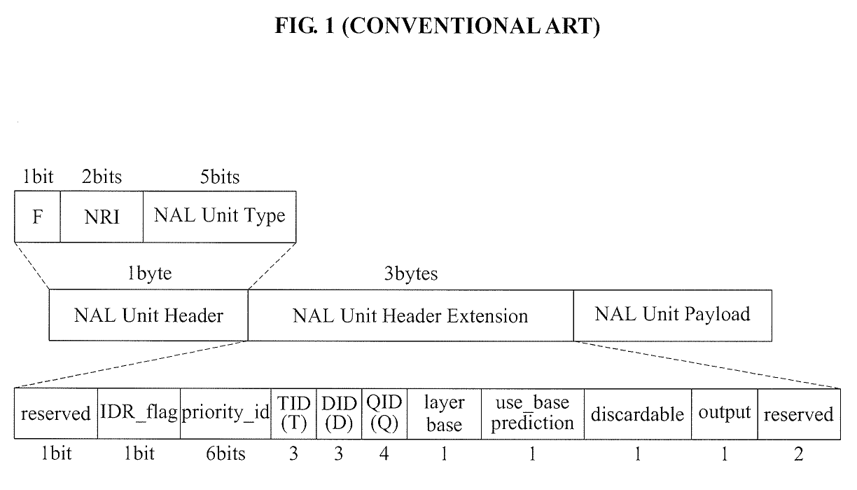

FIG. 2 is a block diagram illustrating a structure of a system for providing a video-based multicast service according to the conventional art;

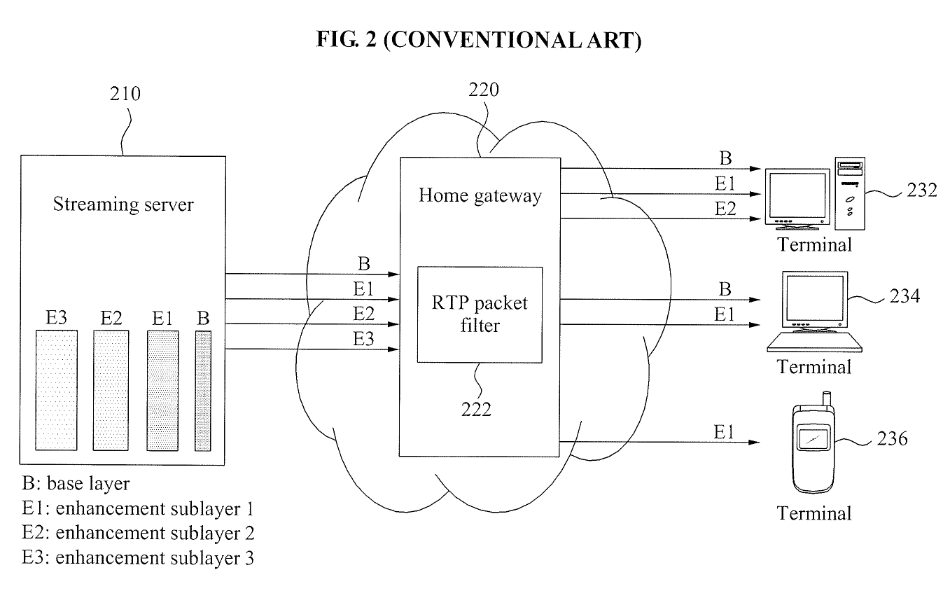

FIG. 3 is a block diagram illustrating a structure of a streaming apparatus for providing a universal video streaming service according to an embodiment of the present invention;

FIG. 4 is a block diagram illustrating a structure of a streaming apparatus for providing a universal video streaming service according to another embodiment of the present invention;

FIG. 5 is a flowchart illustrating a method of providing, by a streaming server of a streaming apparatus, a home gateway with an SVC content file according to an embodiment of the present invention; and

FIG. 6 is a flowchart illustrating a method of receiving, by a home gateway of a streaming apparatus, an SVC content file to provide a terminal with a content according to an embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

Hereinafter, embodiments of the present invention will be described in detail with reference to the accompanying drawings. When it is determined detailed description related to a related known function or configuration they may make the purpose of the present invention unnecessarily ambiguous in describing the present invention, the detailed description will be omitted here.

Provided is a streaming service system and method that may generate a content file, including a plurality of SVC video layer data into a single format, using a pseudo streaming scheme, to thereby provide the generated content file to a home gateway.

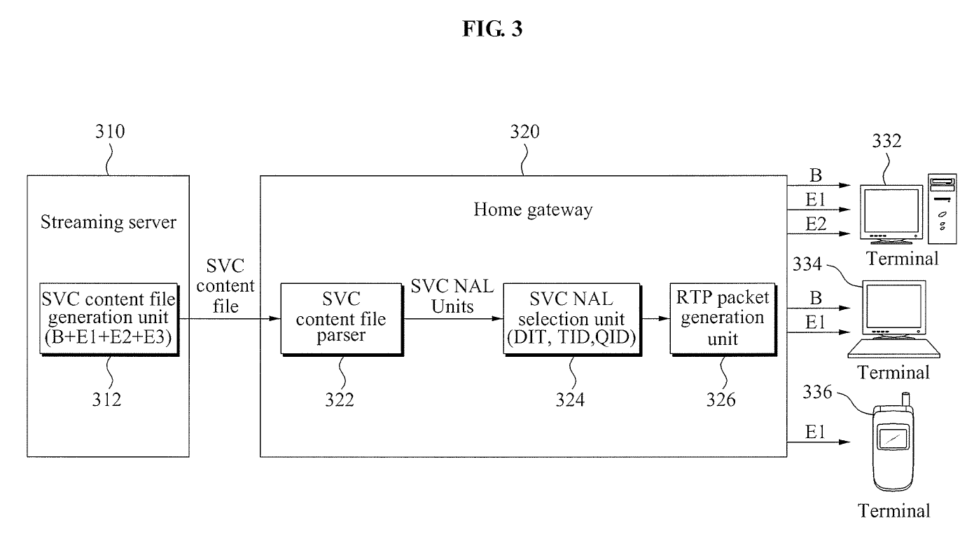

FIG. 3 is a block diagram illustrating a structure of a streaming apparatus for providing a universal video streaming service according to an embodiment of the present invention.

Referring to FIG. 3, the streaming apparatus may include a streaming server 310 and a home gateway 320.

The streaming server 310 may provide a hierarchically coded content to the home gateway 320. The streaming server 310 may include a scalable video coding (SVC) content file generation unit 312.

The SVC content file generation unit 312 may identify a base layer B and scalable enhancement layers E1, E2, and E3 of the hierarchically coded content, generate an SVC content file including both the base layer and the scalable enhancement layers E1, E2, and E3, and transmit the generated SVC content file to the home gateway 320 using a Transmission Control Protocol (TCP). Here, the hierarchically coded content may include the single base layer B and the plurality of scalable enhancement layers E1, E2, and E3 that may be consecutively disposed on the base layer B. Each of the scalable enhancement layers E1, E2, and E3 may express a maximum bitrate, a frame rate, and a resolution that are assigned to a corresponding scalable enhancement layer, based on lower layer information. Specifically, as more scalable enhancement layers are consecutively laid, an SVC content may support various types of bitrates, frame rations, and resolutions.

The home gateway 320 may include an SVC content file parser, an SVC network abstraction layer (NAL) selection unit 324, and a Real-time Transport Protocol (RTP) packet generation unit 326.

The SVC content file parser 322 may receive an SVC content file from the streaming server 310 using the TCP, and may separately extract an SVC NAL unit of a base layer and an SVC NAL unit of a scalable enhancement layer from SVC NAL units that are included in the SVC content file.

The SVC NAL selection unit 324 may select the SVC NAL unit that satisfies a signal-to-noise ratio (SNR), a temporal scalability, and spatial scalability for a client type of each of terminals 332, 334, and 336, using dependencyID (DID), temporal_level_ID (TID), and quality_level_ID (QID) that are included in a header of the SVC content file.

The RTP packet generation unit 326 may perform an RTP packetization for the selected SVC NAL unit to thereby transmit the SVC NAL unit to each of the terminals 332, 334, and 336.

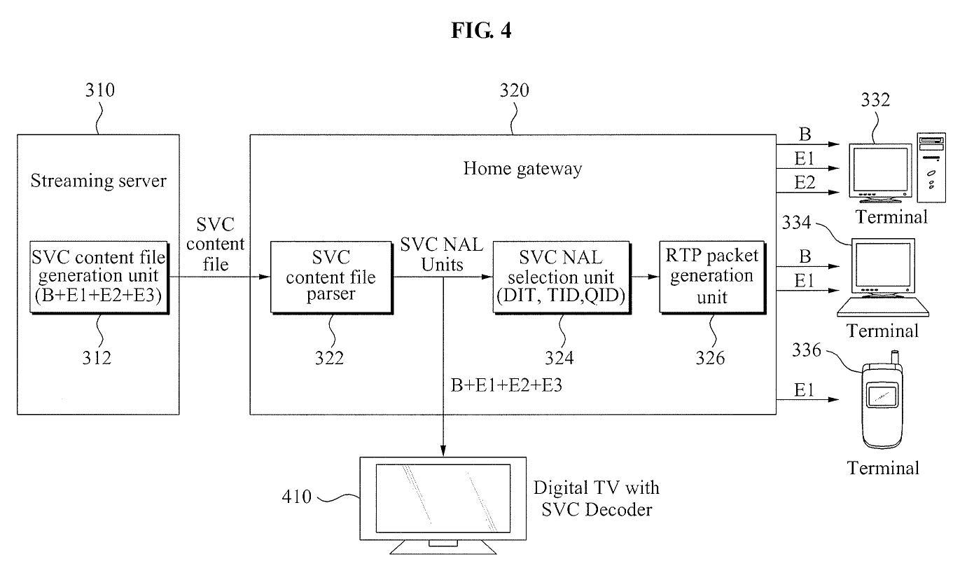

In a home network, a gateway may exist as separate hardware. Also, the gateway may be installed, as a set top box, in a high definition digital TV that functions as a main network system in a living room, and thereby provide a service. In this case, the home gateway and the main system, that is, the digital TV may be integrally provided. In this case, an example of FIG. 3 may be applicable as shown in FIG. 4.

FIG. 4 is a block diagram illustrating a structure of a streaming apparatus for providing a universal video streaming service according to another embodiment of the present invention. Like reference numerals of FIG. 3 are used to the like elements of FIG. 4. Further detailed descriptions related thereto will be omitted here.

Referring to FIG. 4, when a digital TV 410 is connected to a home gateway 320, the digital TV 410 may receive SVC NAL units, including a base layer B and scalable enhancement layers E1, E2, and E3, that are output from an SVC content file parser 322, and may output an SVC content with the best quality.

In FIG. 4, it is possible to provide the SVC content with the best quality, using the digital TV 410, according to a combination of all the layer data, that is, B+E1+E2+E3. At the same time, it is possible to provide an SVC content with an appropriate quality for a resolution and a performance of each of terminals 332, 334, and 336 existing with a home network.

Hereinafter, a streaming service method for a universal video access based on a scalable video coding according to an embodiment of the present invention will be described.

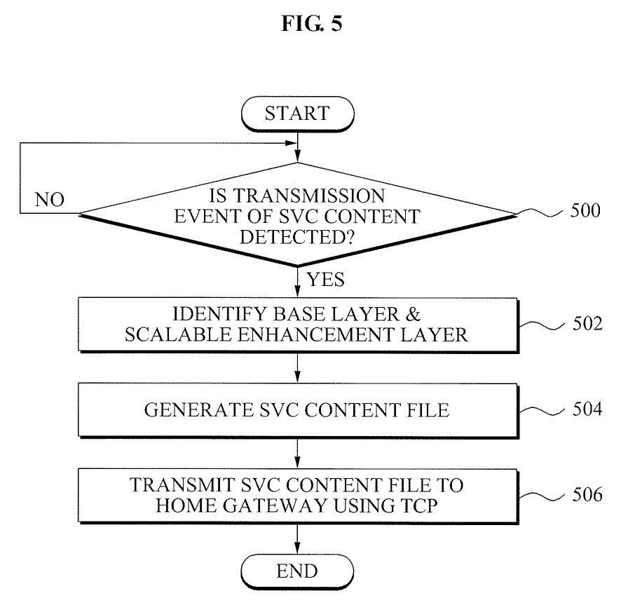

FIG. 5 is a flowchart illustrating a method of providing, by a streaming server of a streaming apparatus, a home gateway with an SVC content file according to an embodiment of the present invention.

Referring to FIG. 5, the streaming server may determine whether a transmission event of an SVC content is detected in operation 500. When the transmission event of the SVC content is detected in operation 500, the streaming server may identify a base layer and a scalable enhancement layer of a hierarchically coded content in operation 502. In operation 504, the streaming server may generate an SVC content file that includes the base layer and the scalable enhancement layer. In operation 506, the streaming server may transmit the SVC content file to the home gateway using a TCP.

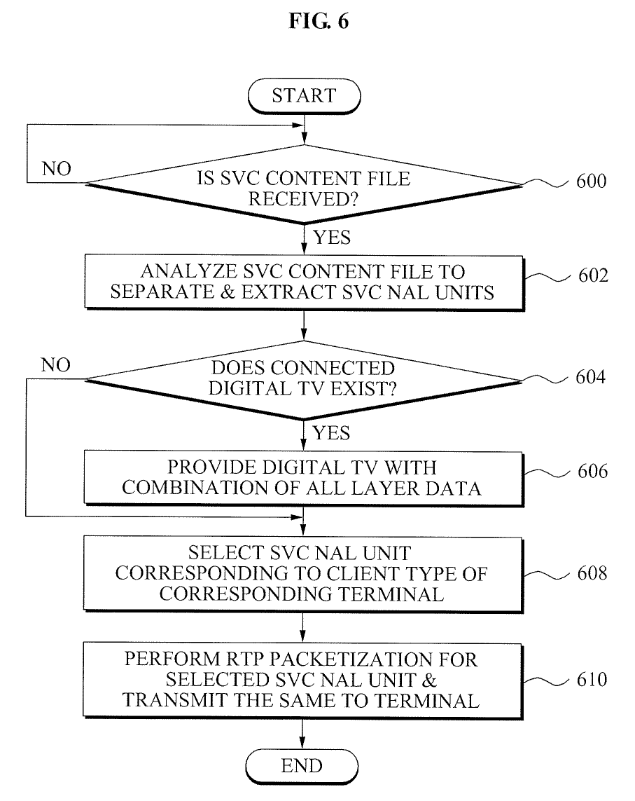

FIG. 6 is a flowchart illustrating a method of receiving, by a home gateway of a streaming apparatus, an SVC content file to provide a corresponding terminal with a content according to an embodiment of the present invention.

Referring to FIG. 6, in operation 600, the home gateway may determine whether the SVC content file is received from a streaming server using a TCP. When the SVC content file is received in operation 600, the home gateway may analyze the SVC content file to separate SVC NAL units into an SVC NAL unit of a base layer and an SVC NAL unit of a scalable enhancement layer in operation 602. In operation 604, the home gateway may verify whether a connected digital TV exists.

When the connected digital TV exists, the home gateway may provide the connected digital TV with the SVC NAL unit of the base layer and the SVC NAL unit of the scalable enhancement layer, and thereby provide an SVC content with the best quality in operation 606.

Conversely, when the connected digital TV does not exist, the home gateway may select an SVC NAL unit corresponding to a client type of each of terminals in operation 608. In operation 610, the home gateway may perform RTP packetization for the selected SVC NAL unit to thereby transmit the SVC NAL unit to a corresponding terminal.

The above-described exemplary embodiments of the present invention may be recorded in computer-readable media including program instructions to implement various operations embodied by a computer. The media may also include, alone or in combination with the program instructions, data files, data structures, and the like. The described hardware devices may be configured to act as one or more software modules in order to perform the operations of the above-described exemplary embodiments of the present invention, or vice versa.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A streaming service system comprising:
a scalable video coding (SVC) content file parser to receive an SVC content file from a streaming server, and to separately extract an SVC network abstraction layer (NAL) unit of a base layer and an SVC NAL unit of a scalable enhancement layer from SVC network abstraction layer (NAL) units that are included in the SVC content file;
an SVC NAL selection unit to select an SVC NAL unit corresponding to a client type of each of terminals; and
a packet generation unit to transmit the selected SVC NAL unit to a corresponding terminal.

2. The streaming service system of claim 1, wherein the SVC content file parser receives the SVC content file using a Transmission Control Protocol (TCP).

3. The streaming service system of claim 1, wherein, when a connected digital TV exists, the SVC content file parser provides the digital TV with the SVC NAL unit of the base layer and the SVC NAL unit of the scalable enhancement layer.

4. The streaming service system of claim 1, wherein the SVC NAL selection unit selects the SVC NAL unit that satisfies a signal-to-noise ratio (SNR), a temporal scalability, and a spatial scalability for the client type of each of the terminals, using dependency_ID, temporal_level_ID, and quality level ID that are included in a header of the SVC content file.

5. The streaming service system of claim 1, wherein the packet generation unit performs a Real-time Transport Packet (RTP) packetization for the selected SVC NAL unit to thereby transmit the SVC NAL unit to the corresponding terminal.

6. A streaming service system comprising:
an SVC content file generation unit to identify a base layer and a scalable enhancement layer of a hierarchically coded content, to generate an SVC content file including both the base layer and the scalable enhancement layer, and to transmit the generated SVC content file to a gateway.

7. The streaming service system of claim 6, wherein the SVC content file generation unit transmits the SVC content file using a TCP.

8. A streaming service method at a gateway, the method comprising:
receiving an SVC content file from a streaming server;
separately extract an SVC NAL unit of a base layer and an SVC NAL unit of a scalable enhancement layer from SVC NAL units that are included in the SVC content file;
selecting an SVC NAL unit corresponding to a client type of each of terminals; and
transmitting the selected SVC NAL unit to a corresponding terminal.

9. The method of claim 8, wherein the receiving receives the SVC content file using a TCP.

10. The method of claim 8, further comprising:
providing, after performing the separately extracting, a connected digital TV with the SVC NAL unit of the base layer and the SVC NAL unit of the scalable enhancement layer when the connected digital TV exists.

11. The method of claim 8, wherein the selecting selects the SVC NAL unit that satisfies an SNR, a temporal scalability, and spatial scalability for the client type of each of the terminals, using dependency ID, temporal_level_ID, and quality level_ID that are included in a header of the SVC content file.

12. The method of claim 8, wherein the transmitting performs an RTP packetization for the selected SVC NAL unit to thereby transmit the SVC NAL unit to the corresponding terminal.

13. A streaming service method at a streaming server, the method comprising:
identifying a base layer and a scalable enhancement layer of a hierarchically coded content;
generating an SVC content file including both the base layer and the scalable enhancement layer; and
transmitting the generated SVC content file to a gateway.

14. The method of claim 13, wherein the transmitting transmits the SVC content file using a TCP.
